(19) United States
(12) Patent Application Publication
(10) Pub. No.: US 2025/0140007 A1
(43) Pub. Date: May 1, 2025

(54) MULTIMODAL TECHNIQUES FOR 3D ROAD MARKING LABEL GENERATION

(71) Applicant: Atieva, Inc., Newark, CA (US)

(72) Inventors: Nikhil Sudhindra Nakhate, Mountain View, CA (US); Ephram Chemali, Fremont, CA (US)

(21) Appl. No.: 18/722,238

(22) PCT Filed: Dec. 19, 2022
(86) PCT No.: PCT/US2022/081958

§ 371 Date: Jun. 20, 2024

Related U.S. Application Data
(60) Provisional application No. 63/265,867, filed on Dec. 22, 2021.

(51) Int. Cl. G06V 20/70; G01S 17/931; G06T 7/73; G06V 10/774; G06V 10/776; G06V 10/778; G06V 20/56

(52) U.S. Cl. CPC G06V 20/70; G01S 17/931; G06T 7/73; G06V 10/774; G06V 10/776; G06V 10/7792; G06V 20/588; G06T 2207/20081; G06T 2207/30256

(57) ABSTRACT

Receiving images captured during motion of the vehicle along a road using a camera mounted to the vehicle; a flat plane is defined relative to the camera; receiving first annotations of the images identifying features of the road and defined by two-dimensional coordinates in a camera image plane; receiving LiDAR data captured during the motion of the vehicle; fitting a plane to the LiDAR data to generate a fitted plane representing a ground plane relative to the vehicle; performing a first transformation where the first annotations of the image plane are projected to the flat plane to generate second annotations; performing a second transformation where the second annotations of the flat plane are projected to the fitted plane to generate third annotations; and training a three-dimensional lane detection model using the images and the third annotations to make image-based predictions without LiDAR input.

### CROSS-REFERENCE TO RELATED APPLICATION

This application claims priority to U.S. Patent Application No. 63/265,867, filed on Dec. 22, 2021, and entitled “MULTIMODAL TECHNIQUES FOR 3D ROAD MARKING LABEL GENERATION,” the disclosure of which is incorporated by reference herein in its entirety.

### TECHNICAL FIELD

This document relates to multimodal techniques for three-dimensional (3D) road marking label generation.

### BACKGROUND

Some vehicles manufactured nowadays are equipped with one or more types of systems that can at least in part handle operations relating to the driving of the vehicle. Some such assistance involves automatically surveying surroundings of the vehicle and being able to take action in view of detected roadways, vehicles, pedestrians, and/or other objects. The development of such systems typically involves substantial efforts in refining the system's ability to accurately detect and interpret its surrounding environment.

### SUMMARY

In an aspect, a method comprises: receiving, in a computer system separate from a vehicle, images captured during motion of the vehicle along a road using a camera mounted to the vehicle, wherein a flat plane is defined relative to the camera; receiving, in the computer system, first annotations of the images, wherein the first annotations identify features of the road and are defined by two-dimensional coordinates in an image plane of the camera; receiving, in the computer system, LiDAR data captured during the motion of the vehicle using a LiDAR mounted to the vehicle; fitting, using the computer system, a plane to the LiDAR data to generate a fitted plane representing a ground plane relative to the vehicle; performing a first transformation in which the first annotations of the image plane are projected to the flat plane to generate second annotations; performing a second transformation in which the second annotations of the flat plane are projected to the fitted plane to generate third annotations; and training a three-dimensional lane detection model using the images and the third annotations, the three-dimensional lane detection model trained to make image-based predictions without LiDAR input.

Implementations can include any or all of the following features. At least one of the first or second transformations is based on a roll and pitch of the camera with respect to the ground plane. The LiDAR data comprises LiDAR point cloud data. The features of the road include a lane of the road. Fitting the plane to the LiDAR data comprises performing a convex optimization. The first transformation is a static transformation, and wherein the second transformation is a dynamic transformation per frame of the images. Training the three-dimensional lane detection model comprises using a loss function to supervise a machine-learning algorithm.

### BRIEF DESCRIPTION OF DRAWINGS

FIG. 1 shows an example of sensor outputs generated during motion of a vehicle.

FIG. 2 shows examples of annotations and transformations.

FIG. 3 shows an example of training a three-dimensional lane detection model.

FIG. 4 shows an example of a method.

FIG. 5 shows an example of a vehicle.

FIG. 6 illustrates an example architecture of a computing device that can be used to implement aspects of the present disclosure.

Like reference symbols in the various drawings indicate like elements.

### DETAILED DESCRIPTION

This document describes examples of systems and techniques that use inputs of multiple modalities to generate labels for three-dimensional (3D) road marking. Such 3D road marking labels can be used for training a 3D lane detection model to make image-based predictions without LiDAR input. For example, the present disclosure can allow 3D labels to be generated with a greater performance than in previous approaches, while restrictive and limiting assumptions of prior approaches can be eliminated. As another example, 3D road marking labels can be generated with reliable accuracy further out than the general reach of LiDAR technology.

In some earlier approaches, two-dimensional (2D) lane locations have been predicted based on 2D labels. Then, to obtain lane locations on the ground (that is, in 3D) assumptions have been made. First, the prior approaches may have been based on, or otherwise taken into account, the assumption that the camera is at a fixed height above the ground. This assumption may have negatively affected previous approaches in that the camera height above ground can vary depending on whether the vehicle is traveling up an incline or down a descent. Second, the prior approaches may have assumed that the vehicle does not bounce up and down. This assumption may have negatively affected previous approaches in that uneven road surfaces can cause a vehicle's vertical placement to change due to the suspension of its wheels. Either or both of the above assumptions can make the mathematical calculations of the 3D road marking label generation somewhat inaccurate and can therefore affect the quality of the 3D model.

The present disclosure, by contrast, can use 3D labels of road markings to enable the 3D model to directly detect in 3D space from an input of 2D images, without requiring LiDAR data as an input when running the model. In particular, 3D road marking label generation according to the present subject matter can be performed without regard to the above assumptions. Hardcoded transformations that may have otherwise been used to obtain detections in 3D space can be omitted.

Examples herein refer to a vehicle. A vehicle is a machine that transports passengers or cargo, or both. A vehicle can have one or more motors using at least one type of fuel or other energy source (e.g., electricity). Examples of vehicles include, but are not limited to, cars, trucks, and buses. The number of wheels can differ between types of vehicles, and one or more (e.g., all) of the wheels can be used for propulsion of the vehicle. The vehicle can include a passenger compartment accommodating one or more persons. At least one vehicle occupant can be considered the driver; various tools, implements, or other devices, can then be provided to the driver. In examples herein, any person carried by a vehicle can be referred to as a “driver” or a “passenger” of the vehicle, regardless whether the person is driving the vehicle, or whether the person has access to controls for driving the vehicle, or whether the person lacks controls for driving the vehicle. Vehicles in the present examples are illustrated as being similar or identical to each other for illustrative purposes only.

Examples herein refer to assisted driving. In some implementations, assisted driving can be performed by an assisted-driving (AD) system, including, but not limited to, an autonomous-driving system. For example, an AD system can include an advanced driving-assistance system (ADAS). Assisted driving involves at least partially automating one or more dynamic driving tasks. An ADAS can perform assisted driving and is an example of an assisted-driving system. Assisted driving is performed based in part on the output of one or more sensors typically positioned on, under, or within the vehicle. An AD system can plan one or more trajectories for a vehicle before and/or while controlling the motion of the vehicle. A planned trajectory can define a path for the vehicle's travel. As such, propelling the vehicle according to the planned trajectory can correspond to controlling one or more aspects of the vehicle's operational behavior, such as, but not limited to, the vehicle's steering angle, gear (e.g., forward or reverse), speed, acceleration, and/or braking.

While an autonomous vehicle is an example of a system that performs assisted driving, not every assisted-driving system is designed to provide a fully autonomous vehicle. Several levels of driving automation have been defined by SAE International, usually referred to as Levels 0, 1, 2, 3, 4, and 5, respectively. For example, a Level 0 system or driving mode may involve no sustained vehicle control by the system. For example, a Level 1 system or driving mode may include adaptive cruise control, emergency brake assist, automatic emergency brake assist, lane-keeping, and/or lane centering. For example, a Level 2 system or driving mode may include highway assist, autonomous obstacle avoidance, and/or autonomous parking. For example, a Level 3 or 4 system or driving mode may include progressively increased control of the vehicle by the assisted-driving system. For example, a Level 5 system or driving mode may require no human intervention of the assisted-driving system.

Examples herein refer to a sensor. A sensor is configured to detect one or more aspects of its environment and output signal(s) reflecting the detection. The detected aspect(s) can be static or dynamic at the time of detection. As illustrative examples only, a sensor can indicate one or more of a distance between the sensor and an object, a speed of a vehicle carrying the sensor, a trajectory of the vehicle, or an acceleration of the vehicle. A sensor can generate output without probing the surroundings with anything (passive sensing, e.g., like an image sensor that captures electromagnetic radiation), or the sensor can probe the surroundings (active sensing, e.g., by sending out electromagnetic radiation and/or sound waves) and detect a response to the probing. Examples of sensors that can be used with one or more embodiments include, but are not limited to: a light sensor (e.g., a camera); a light-based sensing system (e.g., LiDAR); a radio-based sensor (e.g., radar); an acoustic sensor (e.g., an ultrasonic device and/or a microphone); an inertial measurement unit (e.g., a gyroscope and/or accelerometer); a speed sensor (e.g., for the vehicle or a component thereof); a location sensor (e.g., for the vehicle or a component thereof); an orientation sensor (e.g., for the vehicle or a component thereof); an inertial measurement unit; a torque sensor; a temperature sensor (e.g., a primary or secondary thermometer); a pressure sensor (e.g., for ambient air or a component of the vehicle); a humidity sensor (e.g., a rain detector); or a seat occupancy sensor.

Examples herein refer to a LiDAR. As used herein, a LiDAR includes any object detection system that is based at least in part on light, wherein the system emits the light in one or more directions. The light can be generated by a laser and/or by a light-emitting diode (LED), to name just two examples. The LiDAR can emit light pulses in different directions (e.g., characterized by different polar angles and/or different azimuthal angles) so as to survey the surroundings. For example, one or more laser beams can be impinged on an orientable reflector for aiming of the laser pulses. In some implementations, a LiDAR can include a frequency-modulated continuous wave (FMCW) LiDAR. For example, the FMCW LiDAR can use non-pulsed scanning beams with modulated (e.g., swept or “chirped”) frequency, wherein the beat between the emitted and detected signals is determined. The LiDAR can detect the return signals by a suitable sensor to generate an output. As used herein, a higher-resolution region within the field of view of a LiDAR includes any region where a higher resolution occurs than in another area of the field of view. A LIDAR can be a scanning LiDAR or a non-scanning LiDAR (e.g., a flash LiDAR), to name just some examples. A scanning LiDAR can operate based on mechanical scanning or non-mechanical scanning. A non-mechanically scanning LiDAR can operate using an optical phased array, or a tunable metasurface (e.g., including liquid crystals) with structures smaller than the wavelength of the light, to name just a few examples.

Examples herein refer to machine-learning algorithms. As used herein, a machine-learning algorithm can include an implementation of artificial intelligence where a machine such as an assisted-driving system has capability of perceiving its environment and taking actions to achieve one or more goals. A machine-learning algorithm can apply one or more principles of data mining to derive a driving envelope from data collected regarding a vehicle and its related circumstances. A machine-learning algorithm can be trained in one or more regards. For example, supervised, semi-supervised, and/or unsupervised training can be performed. In some implementations, a machine-learning algorithm can make use of one or more classifiers. For example, a classifier can assign one or more labels to instances recognized in processed data. In some implementations, a machine-learning algorithm can make use of one or more forms of regression analysis. For example, a machine-learning algorithm can apply regression to determine one or more numerical values.

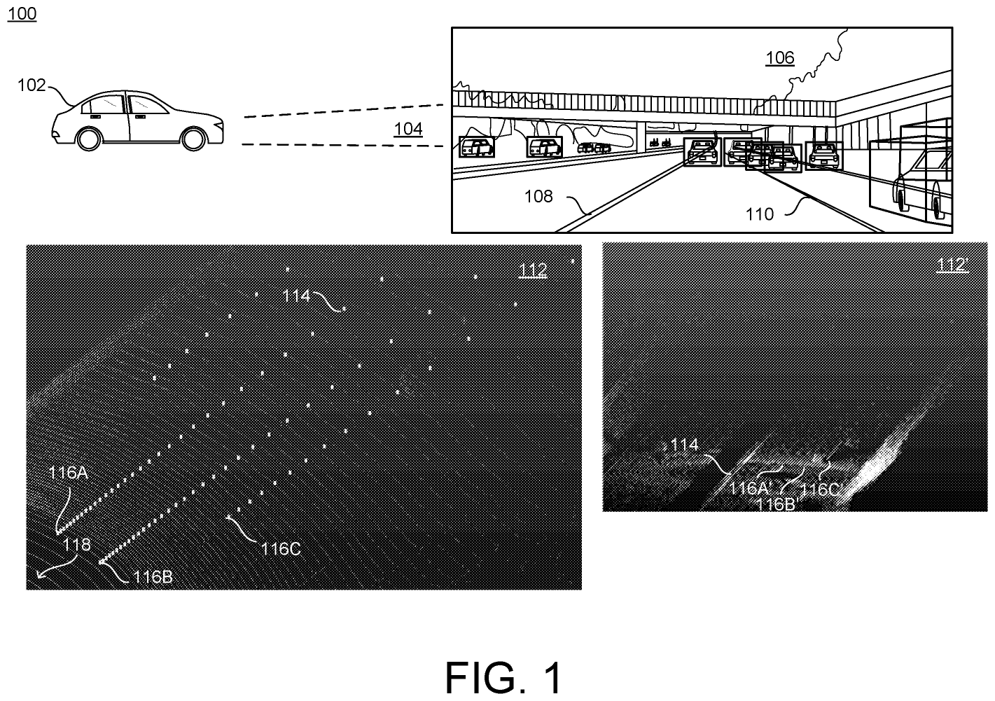

FIG. 1 shows an example of sensor outputs 100 generated during motion of a vehicle 102. Any or all of the sensor outputs 100 can be used with one or more other examples described elsewhere herein. The vehicle 102 is currently in motion along a road 104, as schematically illustrated. The vehicle 102 has an image sensor (e.g., a camera) that is oriented at least in the forward direction and captures frames of image data showing some or all of the road 104, which data is here represented as an image 106 that is part of the sensor outputs 100.

An annotator (e.g., a person that views the image and assigns labels) annotates the image 106 (and others) based on recognizing one or more features in the image 106. One or more annotations can be generated regarding the feature(s). Here, annotations 108 and 110 (e.g., lane boundaries) were added to the image 106. For example, the annotations 108 or 110 can include one or more point-like structures and/or spatial structures defined relative to the features of the image 106. The features of the road can include a lane of the road. The annotations 108 or 110 are made using 2D coordinates defined relative to an image plane of the image 106. For example, the 2D coordinates can be defined using respective values of image-plane variables u and v. The annotations 108 or 110 can be combined with the image 106 as a modified image, or the annotations can be stored separately, in association with the image 106.

The vehicle 102 has a LiDAR that is oriented at least in the forward direction and captures LiDAR data regarding surroundings of the vehicle 102, which LiDAR data is here represented as a LiDAR point cloud 112 that is part of the sensor output 100. The LiDAR point cloud 112 includes points 114 defined using 3D coordinates with respect to a LiDAR coordinate system. The LiDAR coordinate system can be centered at the LiDAR or can be transformed to any other origin. Various features of the road 104 can be reflected by the LiDAR point cloud 112. Here, a set 116A (e.g., an essentially linear row of the points 114) is a portion of the LiDAR point cloud 112 that reflects a feature of the road 104 (e.g., a lane boundary). Similarly, sets 116B-116C (e.g., respective essentially linear rows of the points 114) reflect other features of the road 104. The features represented by the sets 116A-116C can correspond to, say, lane boundaries relative to a location 118 of the vehicle 102. The LiDAR point cloud 112 can effectively extend only a finite distance in one or more directions from the vehicle 102. In some implementations, the individual points 114 of the LiDAR point cloud 112 can begin to get sparse at some approximate distance. For example, the LiDAR point cloud 112 can practically extend only about 60-80 meters in front of the vehicle 102. 3D road marking labels can be generated using the image 106 and the LiDAR point cloud 112, for example as described below.

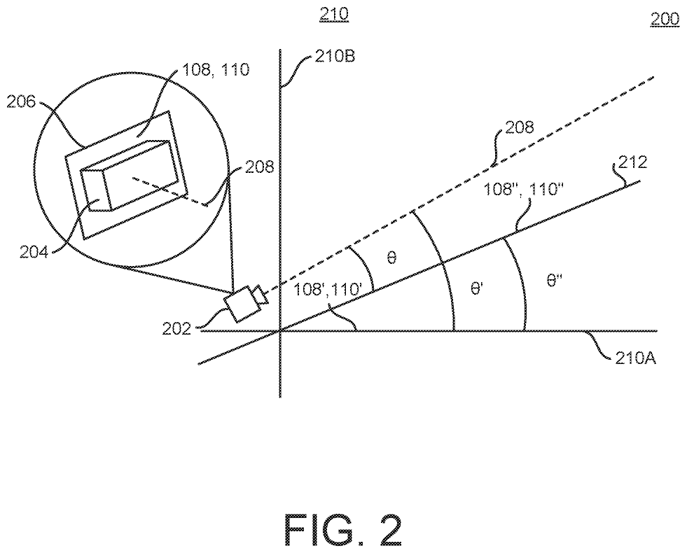

Turning now to FIG. 2, this illustration shows examples of annotations and transformations. Any or all of the annotations and transformations can be used with one or more other examples described elsewhere herein. The annotations and transformations are here schematically represented using a diagram 200 that represents a 3D Cartesian space. A camera 202 is schematically illustrated in the diagram 200. With reference again briefly to FIG. 1, the camera 202 can be mounted in a forward direction of the vehicle 102 and can generate the image 106. An enlargement schematically shows that the camera 202 includes an image sensor 204 (e.g., a charge-coupled device or any other light-sensitive component), and that an image plane 206 can be considered to extend parallel to the image sensor 204. For example, the plane of the image 106 can be referred to as extending along the image plane 206. A camera axis 208 schematically indicates the direction(s) from which light arrives at the image sensor 204.

A coordinate system 210 can be defined relative to—e.g., based on—the coordinate system of the camera 202. The coordinate system 210 can include axes 210A-210B that are perpendicular to each other. For example, the axis 210A can lie in a plane that extends so that the axis 210B is perpendicular to that plane. This plane of the axis 210A is sometimes referred to as a flat plane, and can here be imagined to extend horizontally into the diagram 200.

A plane 212 here likewise extends into the diagram 200. The plane 212 is here represented using a line of the plane 212 that is in the plane of the coordinate system 210. The plane 212 can be obtained by applying a plane-fitting technique to some or all of the LiDAR point cloud 112. In some implementations, applying the plane-fitting technique can involve determining the greatest density of those of the points 114 that are associated with at most a predetermined height. For example, this can seek to ensure that the plane 212 is fitted to the ground of the road 104 as well as possible, and is not fitted to, say, vehicles or other non-ground structures. The plane 212 is sometimes referred to as the fitted plane, or as the ground plane.

In some implementations, an iterative plane-fitting technique can be used in defining the plane 212. For example, the plane-fitting technique can include random sample consensus processing. Any of multiple types of optimization can be applied in fitting the plane 212. In some implementations, a convex optimization can be performed. For example, one can define a convex function representing the discrepancy or error of fit between each candidate for the plane 212 and those of the points 114 having the greatest density, and then seek to minimize that convex function over a convex set.

Transformations can be applied to the annotations 108 or 110 to generate 3D road marking labels. At least one of the transformations can be based on a roll and pitch of the camera 202 with respect to the fitted plane 212 (e.g., the ground plane). Here, an angle θ is schematically illustrated as being defined by the camera axis 208 and the fitted plane 212. An angle θ′ is schematically illustrated as being defined by the camera axis 208 and the flat plane of the axis 210A. An angle θ″ is schematically illustrated as being defined by the fitted plane 212 and the flat plane of the axis 210A. Thus, the relationship is

$${θ}^{″} = {θ}^{′} - θ .$$

In some implementations, a first transformation involves projecting the annotations 108 or 110 to the flat plane of the axis 210A. This can be a static transformation. This first transformation can generate new annotations relative to the flat plane of the axis 210A, here schematically represented as annotations 108′ and 110′ in the flat plane of the axis 210A. For example, this transformation can be performed using a transformation matrix defined at least in part based on the angle θ′.

In some implementations, a second transformation involves projecting the annotations 108′ or 110′ to the fitted plane 212. This can be a dynamic transformation performed for each frame of the camera images (e.g., the image 106). The second transformation can generate new annotations relative to the fitted plane 212, here schematically represented as annotations 108″ and 110″ in the fitted plane 212. For example, this transformation can involve using a transformation matrix defined at least in part on the angle θ″.

That is, one can transform from the image plane 206 to the flat plane of the axis 210A, and thereafter transform from the flat plane of the axis 210A to the fitted plane 212.

Referring again to FIG. 1, a representation 112′ here schematically illustrates both some of the LiDAR point cloud 112 (e.g., the points 114) and road markings 116A′-116C′ that are based on the annotations 108″ and 110″ relative to the fitted plane 212. The road marking 116A′ added to the representation 112′ can essentially correspond to the set 116A; similarly, the road markings 116B′-116C′ added to the representation 112′ can essentially correspond to the sets 116B-116C, respectively. The road markings 116A′-116C′ represent 3D coordinates for features of the road. The combination of the road markings 116A′-116C′ with the LiDAR point cloud 112 to generate the representation 112′ is here shown only for illustrative purposes. The road markings 116A′-116C′ can exist (e.g., as 3D coordinate sets) separate from the LiDAR point cloud 112 or from other LiDAR data. The camera images (e.g., including the image 106) and the annotations 108″ and 110″ can be used in training a model, for example as will now be described.

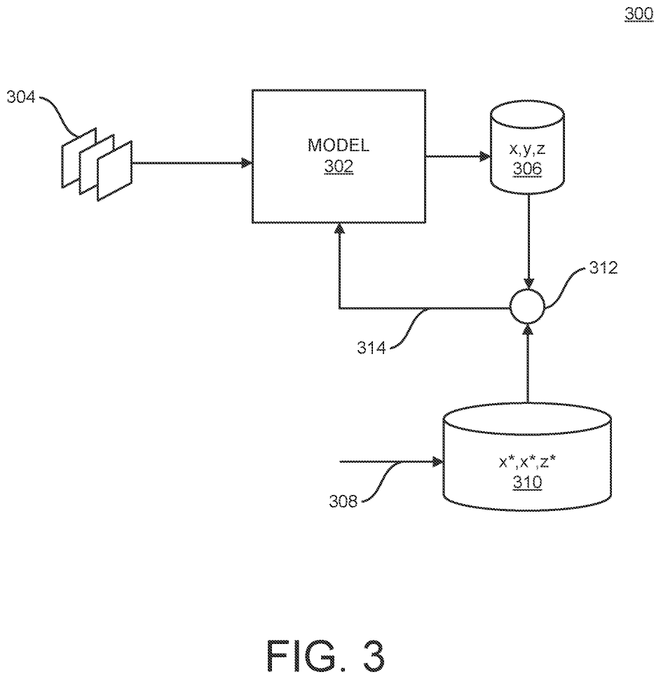

FIG. 3 shows an example 300 of training a 3D lane detection model 302. Some or all of the example 300 can be used with one or more other examples described elsewhere herein. The 3D lane detection model 302 can be generated, trained or otherwise calibrated using a machine-learning algorithm. For example, an iterative process can be applied.

The example 300 involves images 304. In some implementations, the images 304 can be captured using a camera that is mounted to a vehicle used for data-gathering purposes (e.g., the camera 202 in FIG. 2). For example, the images 304 can be received by a system, separate from the vehicle, that is being used for developing and improving the 3D lane detection model 302. The images 304 may have been annotated. For example, the annotations 108 or 110 (FIG. 1) may have been defined in, or relative to, the images 304.

The 3D lane detection model 302 generates an output 306. In some implementations, the output 306 represents an estimate or prediction as to the 3D coordinates of a feature that is visible in at least some of the images 304. In some implementations, the output 306 includes 3D coordinates (e.g., (x, y, z)-coordinates) in a Cartesian coordinate system indicating where the 3D lane detection model 302 has determined the lane features defined in image space-would lie in the 3D coordinate system.

An input 308 schematically indicates that 3D road marking labels can be received. In some implementations, the 3D road marking labels were determined from the images 304 based on transforming, or otherwise performing a projection of, the annotations of one or more of the images 304. For example, the transformations described using the angles θ, θ′, and θ″ in FIG. 2 can be used. A ground truth 310 can be used for training (e.g., developing or otherwise improving, or optimizing, or perfecting) the 3D lane detection model 302. The ground truth 310 includes 3D coordinates (e.g., (x*, y*, z*)-coordinates) in a Cartesian coordinate system.

The output 306 and the ground truth 310 can be compared in one or more ways. In some implementations, a loss function 312 can be applied to the (x, y, z)-coordinates and the (x*, y*, z*)-coordinates. For example, if the output 306 in part predicts coordinates (1, 1, 1) and the ground truth 310 instead indicates coordinates (10, 10, 10), then a result 314 of applying the loss function 312 can represent some function of a value (9, 9, 9), which is the difference between the respective coordinate sets. The result 314 can be applied to train or otherwise adjust the 3D lane detection model 302. Supervising the training using iterative feedback by way of the output 306 and the ground truth 310 being applied to the loss function 312 can improve the accuracy and reliability of the 3D lane detection model 302. In some implementations, this can allow the 3D lane detection model 302 to eventually make image-based predictions without LiDAR input. For example, this can allow the ADAS of the vehicle to omit a LiDAR device and instead rely on camera output for performing lane detection and other functionalities of a self-driving vehicle.

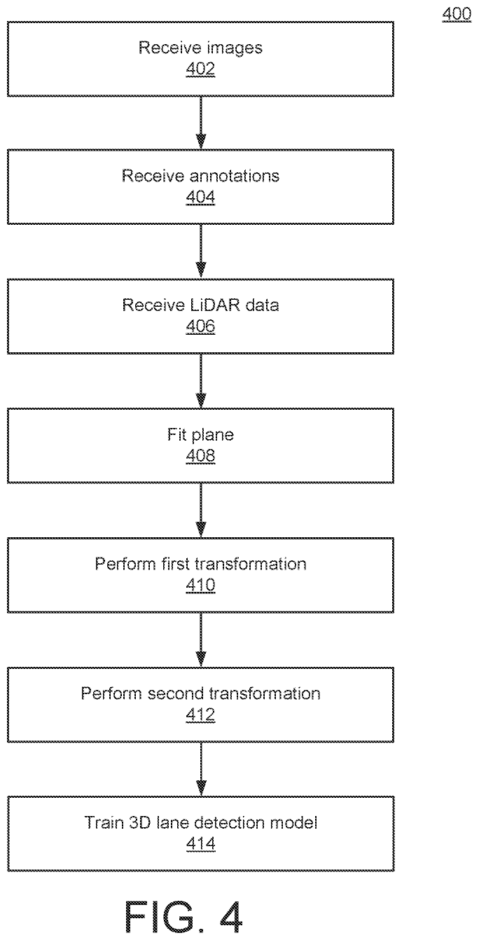

FIG. 4 shows an example of a method 400. The method 400 can be used with one or more other examples described elsewhere herein. More or fewer operations than shown can be performed. Two or more operations can be performed in a different order unless otherwise indicated.

At operation 402, the method 400 includes receiving, in a computer system separate from a vehicle, images captured during motion of the vehicle along a road using a camera mounted to the vehicle. For example, the images 304 (FIG. 3) can be received (e.g., including the image 106) by a system that is training the 3D lane detection model 302. A flat plane is defined relative to the camera. For example, the flat plane of the axis 210A can be defined relative to the camera 202 (FIG. 2).

At operation 404, the method 400 includes receiving, in the computer system, first annotations of the images. For example, the annotations 108 or 110 (FIG. 1) can be received. The annotations identify features of the road (e.g., the road 104) and are defined by 2D coordinates (e.g., variables u and v) in an image plane (e.g., the image plane 206 in FIG. 2) of the camera.

At operation 406, the method 400 includes receiving, in the computer system, LiDAR data captured during the motion of the vehicle using a LiDAR mounted to the vehicle. For example, the LiDAR point cloud 112 (e.g., including the points 114) can be received.

At operation 408, the method 400 includes fitting, using the computer system, a plane to the LiDAR data to generate a fitted plane representing a ground plane relative to the vehicle. In some implementations, the fitted plane 212 (FIG. 2) can be defined based on point densities in the LiDAR data. For example, a convex optimization can be performed.

At operation 410, the method 400 includes performing a first transformation in which the first annotations of the image plane are projected to the flat plane to generate second annotations. For example, the annotations 108 or 110 of the image plane 206 can be transformed into the annotations 108′ or 110′ of the flat plane of the axis 210A.

At operation 412, the method 400 includes performing a second transformation in which the second annotations of the flat plane are projected to the fitted plane to generate third annotations. For example, the annotations 108′ or 110′ of the flat plane of the axis 210A can be transformed into the annotations 108″ or 110″ of the fitted plane 212.

At operation 414, the method 400 includes training a 3D lane detection model using the images and the third annotations. For example, the 3D lane detection model 302 can be trained. The 3D lane detection model can be trained to make image-based predictions without LiDAR input. For example, only the images 304, and not any LiDAR point cloud, can then be used for making the output 306.

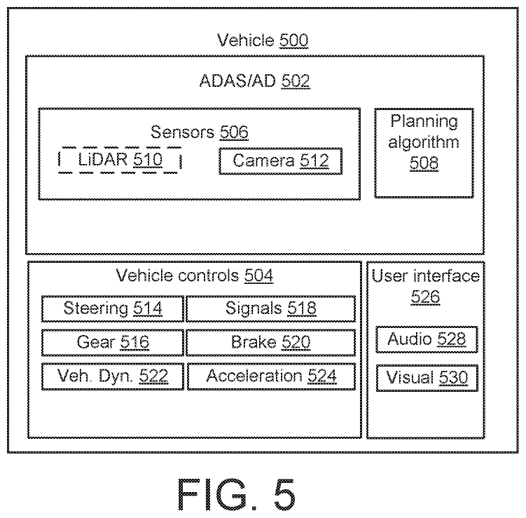

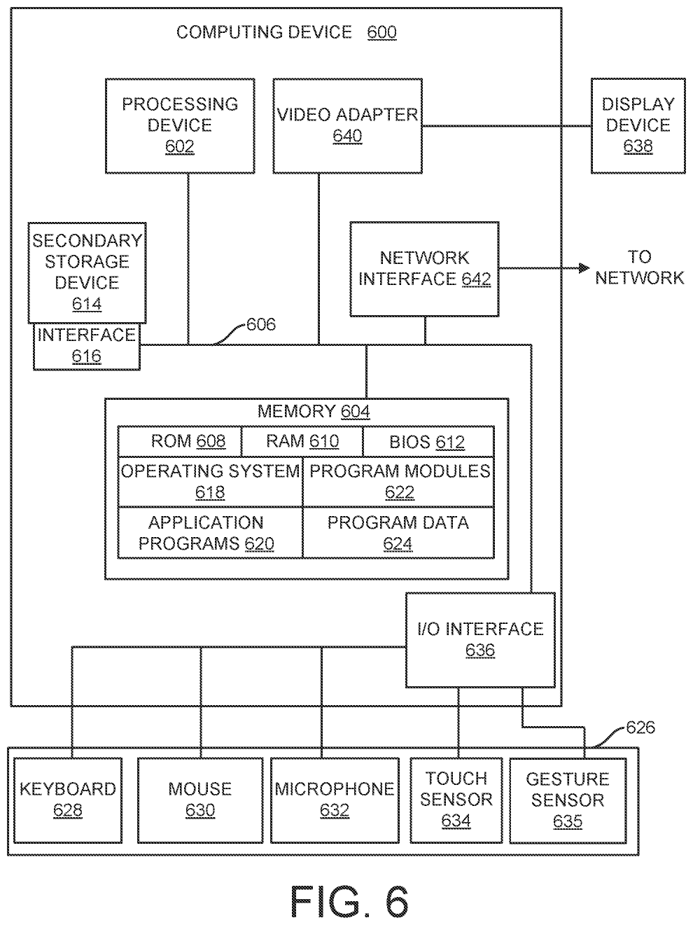

FIG. 5 shows an example of a vehicle 500. The vehicle 500 can be used with one or more other examples described elsewhere herein. The vehicle 500 includes an ADAS/AD system 502 and vehicle controls 504. The ADAS/AD system 502 can be implemented using some or all components described with reference to FIG. 6 below. The ADAS/AD system 502 includes sensors 506 and a planning algorithm 508. The planning algorithm 508 can include, or otherwise make use of, a 3D lane detection model trained using one or more examples described herein. Other aspects of the vehicle 500, including, but not limited to, other components of the vehicle 500 where the ADAS/AD system 502 may be implemented, are omitted here for simplicity.

The sensors 506 are here described as also including appropriate circuitry and/or executable programming for processing sensor output and performing a detection based on the processing. The sensors 506 can include a LiDAR 510. In some implementations, the LiDAR 510 can include any object detection system that is based at least in part on laser light. For example, the LiDAR 510 can be oriented in any direction relative to the vehicle and can be used for detecting at least a distance to one or more other objects (e.g., another vehicle). The LiDAR 510 can detect the surroundings of the vehicle 500 by sensing the presence of an object in relation to the vehicle 500. In some implementations, the LiDAR 510 is a scanning LiDAR or a non-scanning LiDAR (e.g., a flash LiDAR). The LiDAR 510 is here shown in a dashed outline: the LiDAR 510 can be used when gathering data to be processed for providing a ground truth for training a 3D lane detection model, and can be omitted (from the vehicle 500 or another vehicle) where the 3D lane detection model is applied to make image-based predictions.

The sensors 506 can include a camera 512. In some implementations, the camera 512 can include any image sensor whose signal(s) the vehicle 500 takes into account. For example, the camera 512 can be oriented in any direction relative to the vehicle and can be used for detecting vehicles, lanes, lane markings, curbs, and/or road signage. The camera 512 can detect the surroundings of the vehicle 500 by visually registering a circumstance in relation to the vehicle 500. In some implementations, one or more other types of sensors can additionally be included in the sensors 506.

The planning algorithm 508 can plan for the ADAS/AD system 502 to perform one or more actions, or to not perform any action, in response to monitoring of the surroundings of the vehicle 500 and/or an input by the driver. The output of one or more of the sensors 506 can be taken into account. In some implementations, the planning algorithm 508 can perform motion planning and/or plan a trajectory for the vehicle 500. For example, the 3D lane detection model can make image-based predictions without LiDAR input.

The vehicle controls 504 can include a steering control 514. In some implementations, the ADAS/AD system 502 and/or another driver of the vehicle 500 controls the trajectory of the vehicle 500 by adjusting a steering angle of at least one wheel by way of manipulating the steering control 514. The steering control 514 can be configured for controlling the steering angle though a mechanical connection between the steering control 514 and the adjustable wheel, or can be part of a steer-by-wire system.

The vehicle controls 504 can include a gear control 516. In some implementations, the ADAS/AD system 502 and/or another driver of the vehicle 500 uses the gear control 516 to choose from among multiple operating modes of a vehicle (e.g., a Drive mode, a Neutral mode, or a Park mode). For example, the gear control 516 can be used to control an automatic transmission in the vehicle 500.

The vehicle controls 504 can include signal controls 518. In some implementations, the signal controls 518 can control one or more signals that the vehicle 500 can generate. For example, the signal controls 518 can control a turn signal and/or a horn of the vehicle 500.

The vehicle controls 504 can include brake controls 520. In some implementations, the brake controls 520 can control one or more types of braking systems designed to slow down the vehicle, stop the vehicle, and/or maintain the vehicle at a standstill when stopped. For example, the brake controls 520 can be actuated by the ADAS/AD system 502. As another example, the brake controls 520 can be actuated by the driver using a brake pedal.

The vehicle controls 504 can include a vehicle dynamic system 522. In some implementations, the vehicle dynamic system 522 can control one or more functions of the vehicle 500 in addition to, or in the absence of, or in lieu of, the driver's control. For example, when the vehicle comes to a stop on a hill, the vehicle dynamic system 522 can hold the vehicle at standstill if the driver does not activate the brake control 520 (e.g., step on the brake pedal).

The vehicle controls 504 can include an acceleration control 524. In some implementations, the acceleration control 524 can control one or more types of propulsion motor of the vehicle. For example, the acceleration control 524 can control the electric motor(s) and/or the internal-combustion motor(s) of the vehicle 500.

The vehicle 500 can include a user interface 526. The user interface 526 can include an audio interface 528. In some implementations, the audio interface 528 can include one or more speakers positioned in the passenger compartment. For example, the audio interface 528 can at least in part operate together with an infotainment system in the vehicle.

The user interface 526 can include a visual interface 530. In some implementations, the visual interface 530 can include at least one display device in the passenger compartment of the vehicle 500. For example, the visual interface 530 can include a touchscreen device and/or an instrument cluster display.

FIG. 6 illustrates an example architecture of a computing device 600 that can be used to implement aspects of the present disclosure, including any of the systems, apparatuses, and/or techniques described herein, or any other systems, apparatuses, and/or techniques that may be utilized in the various possible embodiments.

The computing device illustrated in FIG. 6 can be used to execute the operating system, application programs, and/or software modules (including the software engines) described herein.

The computing device 600 includes, in some embodiments, at least one processing device 602 (e.g., a processor), such as a central processing unit (CPU). A variety of processing devices are available from a variety of manufacturers, for example, Intel or Advanced Micro Devices. In this example, the computing device 600 also includes a system memory 604, and a system bus 606 that couples various system components including the system memory 604 to the processing device 602. The system bus 606 is one of any number of types of bus structures that can be used, including, but not limited to, a memory bus, or memory controller; a peripheral bus; and a local bus using any of a variety of bus architectures.

Examples of computing devices that can be implemented using the computing device 600 include a desktop computer, a laptop computer, a tablet computer, a mobile computing device (such as a smart phone, a touchpad mobile digital device, or other mobile devices), or other devices configured to process digital instructions.

The system memory 604 includes read only memory 608 and random access memory 610. A basic input/output system 612 containing the basic routines that act to transfer information within computing device 600, such as during start up, can be stored in the read only memory 608.

The computing device 600 also includes a secondary storage device 614 in some embodiments, such as a hard disk drive, for storing digital data. The secondary storage device 614 is connected to the system bus 606 by a secondary storage interface 616. The secondary storage device 614 and its associated computer readable media provide nonvolatile and non-transitory storage of computer readable instructions (including application programs and program modules), data structures, and other data for the computing device 600.

Although the example environment described herein employs a hard disk drive as a secondary storage device, other types of computer readable storage media are used in other embodiments. Examples of these other types of computer readable storage media include magnetic cassettes, flash memory cards, solid-state drives (SSD), digital video disks, Bernoulli cartridges, compact disc read only memories, digital versatile disk read only memories, random access memories, or read only memories. Some embodiments include non-transitory media. For example, a computer program product can be tangibly embodied in a non-transitory storage medium. Additionally, such computer readable storage media can include local storage or cloud-based storage.

A number of program modules can be stored in secondary storage device 614 and/or system memory 604, including an operating system 618, one or more application programs 620, other program modules 622 (such as the software engines described herein), and program data 624. The computing device 600 can utilize any suitable operating system.

In some embodiments, a user provides inputs to the computing device 600 through one or more input devices 626. Examples of input devices 626 include a keyboard 628, mouse 630, microphone 632 (e.g., for voice and/or other audio input), touch sensor 634 (such as a touchpad or touch sensitive display), and gesture sensor 635 (e.g., for gestural input). In some implementations, the input device(s) 626 provide detection based on presence, proximity, and/or motion. Other embodiments include other input devices 626. The input devices can be connected to the processing device 602 through an input/output interface 636 that is coupled to the system bus 606. These input devices 626 can be connected by any number of input/output interfaces, such as a parallel port, serial port, game port, or a universal serial bus. Wireless communication between input devices 626 and the input/output interface 636 is possible as well, and includes infrared, BLUETOOTH® wireless technology, 802.11a/b/g/n, cellular, ultra-wideband (UWB), ZigBee, or other radio frequency communication systems in some possible embodiments, to name just a few examples.

In this example embodiment, a display device 638, such as a monitor, liquid crystal display device, light-emitting diode display device, projector, or touch sensitive display device, is also connected to the system bus 606 via an interface, such as a video adapter 640. In addition to the display device 638, the computing device 600 can include various other peripheral devices (not shown), such as speakers or a printer.

The computing device 600 can be connected to one or more networks through a network interface 642. The network interface 642 can provide for wired and/or wireless communication. In some implementations, the network interface 642 can include one or more antennas for transmitting and/or receiving wireless signals. When used in a local area networking environment or a wide area networking environment (such as the Internet), the network interface 642 can include an Ethernet interface. Other possible embodiments use other communication devices. For example, some embodiments of the computing device 600 include a modem for communicating across the network.

The computing device 600 can include at least some form of computer readable media. Computer readable media includes any available media that can be accessed by the computing device 600. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 600.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 6 is also an example of programmable electronics, which may include one or more such computing devices, and when multiple computing devices are included, such computing devices can be coupled together with a suitable data communication network so as to collectively perform the various functions, methods, or operations disclosed herein.

In some implementations, the computing device 600 can be characterized as an ADAS computer. For example, the computing device 600 can include one or more components sometimes used for processing tasks that occur in the field of artificial intelligence (AI). The computing device 600 then includes sufficient proceeding power and necessary support architecture for the demands of ADAS or AI in general. For example, the processing device 602 can include a multicore architecture. As another example, the computing device 600 can include one or more co-processors in addition to, or as part of, the processing device 602. In some implementations, at least one hardware accelerator can be coupled to the system bus 606. For example, a graphics processing unit can be used. In some implementations, the computing device 600 can implement a neural network-specific hardware to handle one or more ADAS tasks.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A method comprising:
receiving, in a computer system separate from a vehicle, images captured during motion of the vehicle along a road using a camera mounted to the vehicle, wherein a flat plane is defined relative to the camera;
receiving, in the computer system, first annotations of the images, wherein the first annotations identify features of the road and are defined by two-dimensional coordinates in an image plane of the camera;
receiving, in the computer system, LiDAR data captured during the motion of the vehicle using a LiDAR mounted to the vehicle;
fitting, using the computer system, a plane to the LiDAR data to generate a fitted plane representing a ground plane relative to the vehicle;
performing a first transformation in which the first annotations of the image plane are projected to the flat plane to generate second annotations;
performing a second transformation in which the second annotations of the flat plane are projected to the fitted plane to generate third annotations; and
training a three-dimensional lane detection model using the images and the third annotations, the three-dimensional lane detection model trained to make image-based predictions without LiDAR input.

2. The method of claim 1, wherein at least one of the first or second transformations is based on a roll and pitch of the camera with respect to the ground plane.

3. The method of claim 1, wherein the LiDAR data comprises LiDAR point cloud data.

4. The method of claim 1, wherein the features of the road include a lane of the road.

5. The method of claim 1, wherein fitting the plane to the LiDAR data comprises performing a convex optimization.

6. The method of claim 1, wherein the first transformation is a static transformation, and wherein the second transformation is a dynamic transformation per frame of the images.

7. The method of claim 1, wherein training the three-dimensional lane detection model comprises using a loss function to supervise a machine-learning algorithm.
